(19) United States
(12) Patent Application Publication
(10) Pub. No.: US 2005/0079330 A1
(43) Pub. Date: Apr. 14, 2005

(54) Display mat with high-definition graphics

(76) Inventor: Michael L. Tanel, Milwaukee, WI (US)

Correspondence Address: WILHELM LAW SERVICE, S.C., 100 W LAWRENCE ST, THIRD FLOOR, APPLETON, WI, 54911, US

(21) Appl. No.: 10/952,406

(22) Filed: Sep. 27, 2004

Related U.S. Application Data
(63) Continuation-in-part of application No. 10/206,692, filed on Jul. 26, 2002.
Application No. 10/206,692 is a continuation-in-part of application No. 09/750,901, filed on Dec. 27, 2000, now abandoned.

(51) Int. Cl. B32B 3/00

(52) U.S. Cl. 428/204

(57) ABSTRACT

The invention comprehends walk-on, printed display mats. Such mats include a first polymeric layer, a second layer of printing, comprising high-quality graphics. The mat further comprises a generally transparent abuse resistant layer on a top surface of the second and optionally part of the first layer, and optionally an adhesive layer on a bottom surface of the first layer. The generally transparent abuse resistant layer, where present is fused into, and comprises a unitary and inseparable body with, the first and second layers.

### PRIORITY/RELATED APPLICATIONS

This is a continuation-in-part patent application of the currently pending patent application Ser. No. 10/206,692 filed on Jul. 26, 2002, which is in turn a continuation-in-part of now abandoned patent application Ser. No. 09/750,901 filed on Dec. 27, 2000, both of which are incorporated herein by reference in their entireties.

### BACKGROUND

This invention relates to floor graphics and, more particularly, relates to a mat which is supportable on virtually any pedestrian surface, including bare ground, hard flooring, carpeting, and the like, and which mat bears one or more printed graphics images which can include graphics for advertising purposes or the like. The invention additionally relates to methods of producing such mats.

Retail settings may have little available wall space to display promotional literature, resulting in fierce competition for such wall space. Faced with this unpleasant reality, advertisers are becoming increasingly aggressive and creative in seeking new techniques to promote their goods or services. One increasingly popular technique is the use of so-called “floor graphics” as a form of promotional literature. Floor graphics are any of a variety of indicia-bearing advertising and informational products configured to be placed on a pedestrian surface associated with the business establishment, such as in the aisles of the business establishment, just inside or outside the establishment's door, in the establishment's parking lot, or on any other pedestrian surface walked over by prospective viewers of the graphics. Floor graphics are gaining popularity because retailers are increasingly coming to realize that the floor is a prime location for ads, promotional messages, logos, and the like. In fact, some advertisers consider the floor to be superior to walls or other locations as a venue for displaying promotional literature because people tend to look down at the floor to see where they are walking and, hence, are thus more likely to receive the message of promotional literature on the floor than the same literature on the walls or elsewhere. This is particularly true when the floor graphics are placed in bottlenecks within or near a retail establishment such as just inside or outside of the establishment's entrance/exit.

However, designers of floor graphics products face challenges not faced by designers of wall graphics. Unlike wall graphics, floor graphics products are subject to substantial scuffing and soiling potential as passersby walk over and/or upon such floor graphics products. Simple printed paper sheets therefore are not durable enough to be used as floor graphics. Floor graphics image mats can be mounted on the floor so as to remain in place while people walk over and/or upon such floor graphic image products. Otherwise, such floor graphics image products may shift and/or otherwise move under the feet of the pedestrian. The surface of the floor graphics image products also should not be slippery, particularly if the graphics product is used in an outdoor environment or in another location in which the graphics product may become wet.

To be effective in providing floor graphics, a floor graphics product such as a floor graphics mat, cannot impede pedestrian traffic. Traffic might be impeded if the mat were to separate from the floor, such as at the edges of the mat or in the area surrounding the contact point between the mat and a pedestrian's foot. For instance, when a mat has insufficient stiffness, strength or hardness, the mat will “bubble” around a pedestrian's foot. This effect is exacerbated when the mat is used above a soft surface such as carpeting, grass, sand, etc. If such floor graphics mat separates from the floor, and extends substantially upwardly from the floor, e.g. at an edge of the mat, pedestrians may trip and fall when walking on or over the mat.

A mat which is too stiff typically is difficult to “roll up” when it is desired to move the mat to a different location. Also, a mat which is too stiff will not quickly unroll when being installed, such that the edges of the mat stick up from the ground surface. To avoid this problem, the mat is left flat, and transported, delivered and installed without being wound into a roll. However, this increases the difficulty of transport and installation.

It is thus desirable to provide a floor mounted display mat which can be mounted on a floor or other pedestrian surface and walked upon, and which floor mat bears high-definition graphics and/or indicia, and which floor mat facilitates displaying information or promotional indicia in a high-definition manner on a floor or other pedestrian surface.

### SUMMARY

The invention comprehends walk-on, printed display mats, each of which includes a polymeric printed substrate sheet which bears indicia such as high-quality graphics. The mat is adapted and configured to be placed on a pedestrian surface such as a floor or the ground and to generally remain in position as people walk over/upon it. The polymeric substrate sheet preferably is formed from vinyl or another material that can bear relatively detailed graphics applied by any of a number of high-quality e.g. dot-matrix printing techniques. The graphics can be applied either on top of the substrate sheet or, if the substrate sheet is made of a transparent or semi-transparent material, on the bottom of the substrate sheet. Depending upon the particular intended use environment of the mat, the mat can further include adhesives, adhesive strips, and/or other means for attaching and/or removably attaching the mat to the desired pedestrian surface.

In a first family of embodiments, the invention comprehends a display mat, comprising: (a) a first layer comprising a generally planar polymeric sheet having an upper surface and a lower surface, and a thickness of no more than about 0.02 inch between the upper surface and the lower surface; (b) a second layer of printing disposed on at least a portion of at least one of the upper and lower surfaces of the first layer; and (c) a third generally transparent abuse resistant coating layer fused into, and comprising a unitary and inseparable body with, the second layer and the first layer.

In some embodiments, the second layer is disposed on the upper surface of the first layer.

In some embodiments, the second layer is disposed on the lower surface of the first layer.

In some embodiments, the third layer comprises urethane.

In some embodiments, the graphics and/or other indicia define an image having an image thickness dimension of no more than 0.001 inch.

In some embodiments, the second layer comprises graphics and/or other indicia defined by a plurality dots of ink and/or other colorant whereby application of the generally transparent third coating layer causes blending of at least part of ones of the ink and/or other colorant dots with at least part of other ones of the ink and/or other colorant dots.

In some embodiments, the mat further comprising a fourth layer of adhesive in adhering communication with the lower surface of the first layer, the fourth layer of adhesive having a top surface and a bottom surface, and an adhesive layer thickness between the top surface and the bottom surface, thickness of the fourth layer of adhesive being no more than about the thickness of the first layer.

In a second family of embodiments, the invention comprehends a display mat, comprising: (a) a first layer comprising a generally planar vinylidene chloride copolymer film having an upper surface and a lower surface[, and a thickness of no more than about 0.02 inch between the upper surface and the lower surface; (b) a second layer of graphics and/or other indicia printed as generally circular dots in a dot matrix image on at least one of the upper and lower surfaces of the first layer; and (c) a third generally transparent abuse resistant urethane-based coating layer fused into, and comprising a unitary and inseparable body with, the second layer and the first layer, dots in the dot matrix image of the second layer being visually distorted, moved, or otherwise mobilized from circularity of such dots.

In some embodiments, the first layer comprises a PVC polymer having an average molecular weight of about 60,000 to about 150,000.

In some embodiments, the first layer has a specific gravity of about 1.32 to about 1.45.

In some embodiments, the mat is adapted and configured to generally resist long-term deformation when a force of about 1,600 psi is applied to an area of about 0.06 square inch.

In some embodiments, the mat further comprising a fourth adhesive layer having a top surface and a bottom surface, and a thickness between the top surface and the bottom surface, the thickness of the fourth adhesive layer being no more than the thickness of the first layer.

In a third family of embodiments, the invention comprehends a display mat, comprising: (a) a first layer comprising a generally planar polymeric sheet having an upper surface and a lower surface, and a thickness of no more than about 0.02 inch between the upper surface and the lower surface; (b) a second layer of printing disposed on at least a portion of at least one of the upper and lower surfaces of the first layer; and (c) a third layer of adhesive having a top surface and a bottom surface, and communicating with at least a portion of the lower surface of the first layer, a thickness of the third layer being defined between the top and bottom surfaces of the third layer.

In some embodiments, the thickness of the third layer is less than the thickness of the first layer.

In some embodiments, the thickness of the first layer is less than about 0.01 inch.

In some embodiments, the second layer has an image thickness of less than 0.001 inch.

In some embodiments, the first layer comprises an extruded vinylidene chloride copolymer film.

In some embodiments, the first layer comprises no more than about 20 percent plasticizer.

In some embodiments, the mat further comprising a fourth coating layer comprising generally transparent abuse resistant material fused into, and comprising a unitary and inseparable body with, the second layer and the first layer.

In some embodiments, the third adhesive layer comprises a substrate having first and second opposing surfaces, the substrate being coated on the first surface with a first adhesive effective to bond the substrate to the first layer, and coated on the second surface with a second adhesive effective to releasably and bond the substrate to an underlying pedestrian surface such that the second adhesive releases cleanly from commonly-used manufactured pedestrian surfaces when the mat is pulled away from such pedestrian surfaces, while remaining bonded to the substrate.

In some embodiments, the first adhesive is different from the second adhesive.

### BRIEF DESCRIPTION OF THE DRAWINGS

Exemplary embodiments of the invention are illustrated in the accompanying drawings.

FIG. 1 shows a top plan view of a section of a floor bearing a first embodiment of display mats of the invention.

FIG. 2 shows a detail top view of a portion of the display mat of FIG. 1.

FIG. 3 shows a side sectional elevation view of a portion of the display mat of FIG. 1.

FIG. 4 shows an exploded perspective view of the display mat of FIG. 1.

FIG. 5 shows a top plan view of a second embodiment of display mats of the invention.

FIG. 6 shows a side cross-section of an elevation view of a portion of the display mat of FIG. 5.

FIG. 7 shows a flowchart of a process for constructing the display mat of FIG. 1.

FIG. 8 shows a cross section view of a third embodiment of display mats of the invention having an optional second layer of coating and embedded grit.

FIG. 9 shows a cross section view of the display mat of FIG. 8 with a single layer of coating and no embedded grit.

FIG. 10A shows a bottom view of a fourth embodiment of display mats of the invention.

FIG. 10B shows a bottom view of the display mat of FIG. 10A, having adhesive applied only adjacent the outer perimeter of the mat.

FIG. 11A shows a cross section view of the display mat of FIG. 10A including a single adhesive layer.

FIG. 11B shows a cross section view of the display mat of FIG. 10A including a multi-layer adhesive structure.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

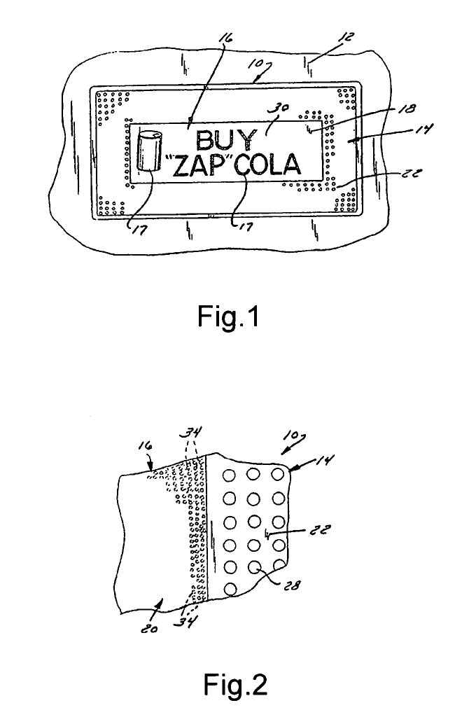

Referring now to the drawings and initially to FIG. 1 in particular, a display mat 10 constructed in accordance with a first embodiment of the invention is shown located on a pedestrian surface 12. The surface 12 may comprise an interior floor, an exterior slab, or any surface that people walk over or near. Because the mat 10 can be merely placed on top of the surface 12 and/or adhered to surface 12, the surface can be made from a variety of materials, including concrete, linoleum, asphalt, carpet, wood, or even dirt or grass. As one example, in the embodiment of FIGS. 1-4 in which the display mat 10 is an outdoor mat, the surface can well be concrete, dirt, asphalt, or others.

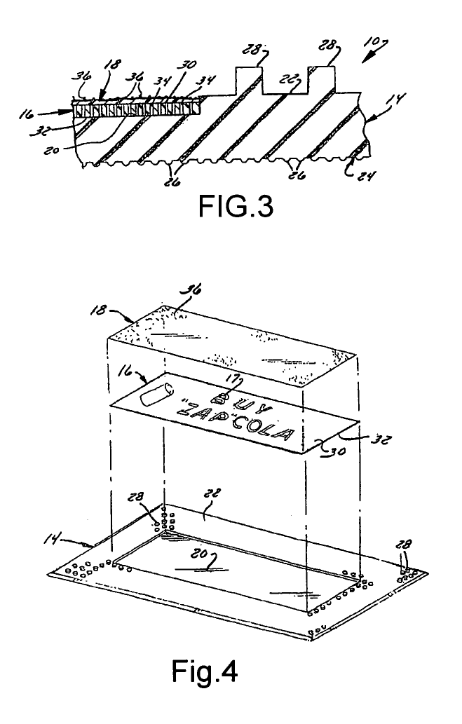

Still referring to FIG. 1, the display mat 10 of the illustrated embodiment is particularly well-adapted for indoor/outdoor use. In some embodiments, display mat 10 can include a rubber substrate 14, a sheet 16, and a protective layer 18 (shown in FIGS. 3 and 4) coated onto the vinyl sheet 16. Indicia in the form of graphics 17 are printed on sheet 16. Sheet 16 is fused to substrate 14 as described in more detail elsewhere herein. In some embodiments, such as those illustrated in FIGS. 2-4, sheet 16 fills only a center portion 20 of an upper surface of substrate 14 and is surrounded by a border 22 formed entirely of the upper surface of substrate 14.

However, in other embodiments, the sheet can also completely overlie the substrate. In yet other embodiments, substrate 14 is not utilized in any regard, and thus the mat comprehends a single sheet which is printed upon and at least partially sealed and/or otherwise coated on its top surface with a protective layer.

Referring to FIGS. 2-4, the substrate 14 has a lower surface 24 configured to rest on the pedestrian surface 12 (FIG. 1) and an upper surface having at least a portion 20 configured to be fused to the lower surface of the sheet 16. Because the display mat 10 illustrated in FIGS. 1-4 is configured for use in wet or slippery conditions, in some embodiments substrate 14 is configured to minimize slippage both between the substrate and the pedestrian surface 12, and between the substrate and the feet of people walking on the substrate. At least one of bottom surface 24 and border 22 on the top surface of the substrate can be non-planar to reduce hydroplaning potential, while in other embodiments border 22 and/or surface 24 are substantially planar.

In the embodiments in which bottom surface 24 is non-planar, bottom surface 24 can include an array of relatively small protrusions 26 which extend against pedestrian surface 12 and which act as grippers which inhibit slippage between mat 10 and pedestrian surface 12 (FIG. 1). Border 22 of the upper surface has a plurality of relatively large, upwardly facing lugs or grippers 28 around an outer perimeter of substrate 14, which lugs or grippers are engaged by the feet of passersby walking on the substrate, to enhance the non-slip characteristics of the upper surface of the display mat.

Grippers 28 are not required or even desired, in many applications. Other materials, such as carpet strips, can also be vulcanized to or otherwise mounted on border 22. If display mat 10 is configured for use on a carpet, attachment substances and/or devices e.g. adhesives, adhesive strips, hook and loop fasteners, and/or other attachment devices, can be mounted on bottom surface 24 to enable removable mounting of display mat 10 onto the carpet.

In embodiments which utilize a substrate 14, the substrate can be of any desired thickness. The substrate typically is at least 0.05 inch thick to provide the weight and rigidity desired to prevent slipping or rumpling of the mat. While thicknesses above 0.13 inch are uncommon in most applications, mats having a thickness of 0.25 inch or more can be used as e.g. cushioned mats designed to provide shock absorbency as passerby walk over such mat. The mats can be of any desired top-projection area.

If display mat 10 is wider than the width of available rubber strips, two or more adjacent strips of unvulcanized rubber can be butt-joined at their lateral edges prior to vulcanization and even prior to lamination of sheet 16 to substrate 14, thereby permitting production of display mats of virtually any desired width and length.

Substrate 14 can be made from any material capable of being fused to overlying sheet 16 so as to negate the need to glue sheet 16 to substrate 14. Natural or synthetic rubber can be used because such rubber cooperates in fusing a vinyl sheet 16 to such substrate 14 in a low pressure vulcanization process as described elsewhere herein.

However, a variety of other materials also can be used. For instance, substrate 14 can be formed from the same or similar vinyl as sheet 16, in which case sheet 16 can be fused to substrate 14 by pressing sheet 16 against substrate 14 before the mating surfaces of one or both of the layers is fully cured, and holding such layers together as the curing process progresses. Other possible materials suitable for use as substrate 14 include polyester, polyurethane, polypropylene, polyethylene, silicone, various elasticized materials, and a wide variety of other polymers and elastomers, including acrylics.

Referring to FIGS. 1-4, sheet 16 comprises a printed polymer sheet having an upper surface 30, and having a lower surface 32 fused to the upper surface of substrate 14. When used in conjunction with substrate 14, sheet 16 can be air permeable so as to prevent air from being trapped between sheet 16 and substrate 14 during the mat manufacturing process. In the embodiment illustrated in FIG. 2, sheet 16 is rendered air permeable by forming an array of relatively small holes 34 in the sheet. The perforation density and sizes of holes 34 can vary from application to application. However, as a practical matter, holes 34 are as small as practically possible so as to prevent migration of unvulcanized rubber or another uncured substrate material through holes 34 to upper surface 30 of sheet 16. The perforation density can be at least 100, and preferably about 150 or more, holes per square inch. Each hole preferably has a diameter of no more than about 0.0001 inch to about 0.0005 inch. Holes 34 preferably are created simply by puncturing sheet 16 so as to not remove material from the sheet. However, any of the other known hole forming processes are contemplated so long as other features of the resulting material are not unacceptably impeded.

Holes 34 are not required where sheet 16 is formed from a naturally air permeable material or where sheet 16 is mounted on substrate 14 using a technique which prevents air bubbles from being trapped between sheet 16 and substrate 14. For instance, an imperforate sheet can conceivably be laminated to a rubber sheet in a process which forces trapped air outwardly from between the layers as the laminating process proceeds. Also, holes 34 are not required in embodiments in which substrate 14 is absent, and/or other embodiments in which no layer-upon-layer mounting is utilized.

The thickness of sheet 16 depends upon, inter alia, the desired application and the printing to be employed. Sheet 16 typically has a thickness of between 0.004 inch and 0.018 inch and more typically between 0.008 inch and 0.01 inch. However, relatively thicker sheets, on the order of 0.050 inch and thicker, can be used. Also, relatively thinner sheets, such as 0.002 inch and thinner can be used as designed.

Sheet 16 can be made of a variety of materials which are suitable for having high quality graphics printed on them, which are sufficiently durable to be walked upon, and which provide a suitable use life when utilized in the intended environment. Vinyl is an acceptable material for use in fabricating sheet 16 because graphics can be printed on a wide variety of vinyl products using any of a number of conventionally-known printing techniques. Graphics images 17 typically are applied to upper surface 30 of sheet 16. However, where sheet 16 is transparent or semi-transparent, reverse graphics can be applied to lower surface 32 of sheet 16 such that the graphics images are visible through sheet 16. This latter possibility is attractive in applications in which the graphics are easily scuffed and/or no protective coating 18 is utilized. It is also possible to print graphics to both surfaces 30 and 32 of sheet 16.

Graphics images 17 can be formed from a variety of water or solvent-based paints, inks, dyes, pigments, and/or other colorants. For example, graphics images 17 can be applied by ink jet printing, laser printing, brush painting, pen writing, electrostatic printing, screen printing, litho-printing, photographic printing, holographic printing, die sublimation, or lenticular printing. The preferred printing technique varies depending upon the material of sheet 16, physical structure of sheet 16, the type of graphics material being applied to the sheet, and the stage at which the graphics are applied during the mat production process. Hence, offset printing is suitable if the sheet is a relatively thin, flexible sheet capable of being subjected to an offset printing process and e.g. if graphics images 17 are printed onto sheet 16 prior to the fusion of sheet 16 to rubber substrate 14.

Referring now to FIG. 3, protective coating 18 covers substantially the entire upper surface 30 of sheet 16, thereby protecting printed graphics image(s) 17 and the material of the sheet, itself, from scuffs and soiling. Coating 18 is relatively thin and, in fact, need only be thick enough to adequately protect the underlying vinyl sheet.

Thicknesses of 0.001 inch to 0.01 inch are typical, with a thickness of about 0.002 inch to 0.004 inch being preferred. Relatively thicker layers, on the order of 0.03 inch or thicker, can also be applied, preferably by coating or alternatively in a subsequent lamination step in which a clear protective sheet is laminated onto upper surface 30 of sheet 16. Any of a variety of transparent, semi-transparent and/or generally transparent materials can be used as coating 18.

In embodiments which include substrate layer 14 vulcanized to sheet 16, it is also possible to vulcanize a clear sheet of vinyl or similar material to the upper surface of sheet 16 during, for example, the vulcanization operation, thereby negating the need to invoke a separate coating step. Suitable coating materials for coating 18 include vinyl, rubber, nylon, polyurethane, silicone, PVC, PVC plastisol, acrylic, lacquer, varnish, or any of a variety of elasticized materials.

In some embodiments, coating 18 is not utilized in the invention, particularly in applications in which sheet 16 is relatively resistant to scuffing and soiling and/or in which graphics images 17 are printed on bottom surface 32 of sheet 16 as opposed to being printed on upper surface 30.

Referring now to FIG. 4, a layer of grit 36 can be embedded in coating 18 to increase the coefficient of friction of the coated sheet by reducing the planarity of its upper surface. Grit 36 preferably is encapsulated by coating 18, e.g., by depositing the grit between two layers of the coating. Grit 36 can be of any suitable size, density, and material. Suitable grit materials include aluminum oxide, glass, diamond, metal chips, shale, ceramics, and others. A similar layer of grit and/or a clear coating layer can be applied to bottom surface 24 of substrate 14 to prevent mat 10 from moving along pedestrian surface 12. This technique is particularly suitable in applications in which a mat having an otherwise-smooth bottom surface is used in applications in which slippage between the mat and the pedestrian surface is a concern.

In use, display mat 10 of FIGS. 1-4 is installed upon pedestrian surface 12. In preferred embodiments, the installation comprehends affixing, e.g. adhering, gluing, or otherwise affixing the mat to surface 12. However, in alternative embodiments, there is no need to glue or otherwise affix the mat 10 to surface 12. Once placed at the desired location, mat 10 remains generally fixed in that location without slipping or crumpling as passersby walk over it.

Protective coating 18 prevents printed graphics 17 on sheet 16 from becoming scuffed or soiled, and grit 36 embedded in coating 18 prevents sheet 16 from becoming slippery if the mat gets wet. In the embodiments in which mat 10 is not affixed to surface 12, to remove display mat 10, a user merely picks it up and thus may not need to use any special tools or equipment. Once removed, the mat can be rolled, folded, or stored flat and reused upon demand.

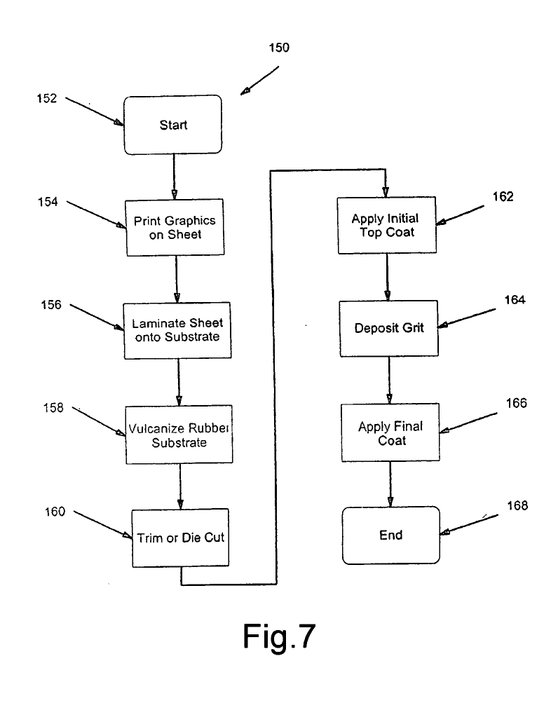

As discussed above, a display mat can be produced in any of the variety of processes which result in fusing of the printed sheet to the underlying substrate. The process employed varies with, inter alia, the properties of the materials used in the substrate and the printed sheet. Referring now to FIG. 7, a possible process 150 of producing display mat 10 of FIGS. 1-4 is illustrated.

Process 150 proceeds from Start in Block 152 to Block 154, in which graphics 17 are printed on sheet 16 using one or more of the printing techniques described above. Also as described above, graphics images 17 can be printed on either upper surface 30 or lower surface 32 of sheet 16. Where sheet 16 is to be perforated to render the sheet air permeable, then the printing step preferably occurs after sheet 16 is perforated, although not necessarily before the sheet is optionally stacked onto substrate 14. Graphics images 17 can also be applied after sheet 16 is optionally fused to substrate 14, provided that (i) graphics images 17 are applied to upper surface 30 of sheet 16, and provided that (ii) the printing technique is compatible with a relatively thick two-component mat 10.

Next, in Block 156, sheet 16 is stacked on top of substrate 14 and preferably laminated to substrate 14 to force air outwardly from between the two layers 14 and 16. Sheet 16 can be laminated to substrate 14 by feeding sheet 16 and substrate 14 through a heated nip formed between two rollers having a nip pressure of e.g. about 35 psi and an outer surface temperature of e.g. about 150 degrees F. Lamination in this manner not only forces the air outwardly from between substrate 14 and sheet 16, but renders the material of one or both layers sufficiently tacky to hold them together during the subsequent handling and vulcanization processes. That this laminating step may not be required where the vinyl sheet 16 is sufficiently perforated or air permeable to permit air to easily bleed from between substrate 14 and sheet 16 when sheet 16 is laid on top of rubber substrate 14. Hence, the choice of whether to include a lamination step in a particular process depends on manufacturer preference and/or the properties of sheet 16 and/or substrate 14.

Next, in step 158, rubber substrate 14 is vulcanized with vinyl sheet 16 on substrate 14, so as to fuse bottom surface 32 of vinyl sheet 16 to upper surface 20 of rubber substrate 14. In such process, the laminated sheet/substrate combination may be placed in a mold and heated for a period of time and at a pressure which is sufficient to cure the rubber and to fuse sheet 16 to substrate 14. Suitable temperature ranges, pressure ranges, and dwell times vary from application to application, as known to those skilled in the art. For instance, because some inks begin to break down at temperatures above about 400 degrees F., maximum temperatures may be limited to about 400 degrees F. in applications in which heat-sensitive ink is printed on sheet 16 prior to vulcanization.

However, higher temperatures can be utilized in applications which employ more temperature-stable ink or in which the ink is printed onto sheet 16 after vulcanization is complete. As a practical matter, the vulcanization process typically takes place at temperatures between about 150 degrees F. and about 400 degrees F., pressures between about 10 pounds per square inch (psi) and about 2000 psi, and dwell times of between about 2 minutes and about 20 minutes. Any of a variety of presses and molds are suitable for this process. A so-called “flexible cavity press”, having an interior having flexible periphery is preferred because mats of different shapes, sizes, and thicknesses can be accommodated by the same mold. Flexible cavity presses are well known to those skilled in the Vulcanization art.

It is also possible to roughen upper surface 30 of sheet 16 sufficiently during the vulcanization process to render upper surface 30 sufficiently rough that use of grit 36 is obviated in some use environments which would otherwise suggest use of grit 36. Such roughening process entails vulcanizing the rubber at a temperature at or above the softening point of the vinyl material (typically between 300 degree F. and 400 degree F.) in a cavity having an upper surface which is sufficiently textured to enable the upper surface of sheet 16 to realize a correspondingly textured surface, after such process. Namely, the cavity utilized in the vulcanization process can be textured so as to emboss, deboss, and/or otherwise impart a textured surface into or upon sheet 16, whereby the textured top surface of the sheet is sufficiently rough after the softened sheet hardens to negate the need for a grit layer at the top of the sheet.

In some embodiments, as a result of the vulcanization process, bottom surface 32 of sheet 16 is fused to upper surface 20 of rubber substrate 14 about at least substantially the entire contact area thereof. The resultant layered mat 10 can be bent, rolled, or otherwise manipulated without layers 14 and 16 separating, whereby the result is a durable, reusable mat 10.

After the vulcanization process is complete, the edges of the resultant display mat 10 are trimmed or die cut to size in Block 160. Then, in Block 162, an initial layer of protective coating 18 is applied over upper surface 30 of sheet 16, and grit 36 is deposited onto coating 18 in Block 164.

The urethane and/or polyurethane coating “bites” into, defuses into, fuses with, pierces, infiltrates, and/or otherwise at least partially penetrates, upper surface 30 of printed vinyl sheet 16 at this time, hindering or preventing separation of coating 18 from sheet 16. Namely, at least part of sheet 16, e.g. the upper surface of sheet 16, changes viscosity so as to enable sheet 16, coating 18, and/or image 17, to cooperate and thus form a single, unitary, fusionally blended medium, the components of which are generally inseparable from each other. Finally, an optional second layer of protective coating 18 is applied over grit 36 in Block 166 to encapsulate the grit in the protective coating, and the process proceeds to End in Block 168. As mentioned above, coating 18 is not required in all applications and can be applied as a separate sheet as opposed to a liquid coating. When the coating is applied as a sheet, the coating can be either laminated (glued) to sheet 16, or fused to sheet 16 during the vulcanization step.

Numerous urethane bases coatings are suitable for use in coating 18 and are thus well within the scope of the current invention, including water-based urethanes, multi-part e.g. two-part urethanes, solvent-based urethanes, oil-based urethanes, moisture-cured urethanes, conversion varnishes, and others.

As one example, when it is desirable to relatively reduce the curing/drying time realized by coating 18, 118 (FIGS. 3, 6, 8, 11A, 11B), a two-part urethane is used. Such suitable two-part urethanes include polyol-based urethanes and further include, for example, isocyanate-based accelerators used in conjunction with the polyol-base.

Also when it is desirable to relatively reduce the curing/drying realized by coating 18, 118, a water-based urethane can be used. Such water-based urethanes include cross-linked, acrylic-modified urethanes, and others.

Alternatively, suitable solvent-based urethanes include certain urethane alkyd resins, for example having viscosities of about 3000 cps to about 5000 cps as defined by the Brookfield Viscometer at 30 degrees C., which have an acid value (maximum) of about 5 mgKOH/gm, and a specific gravity of about 0.9 (gm/cm²). Also, certain aliphatic and e.g. moisture cured solvent based-urethanes are suitable for use in coating 18, 118.

Those skilled in the art are well aware of suitable additives which can be combined with coating 18, 118 to enhance certain properties thereof as desired, such as durability properties, flexibility properties, application ease properties, and/or others. As one example, certain cutting agents, e.g. “cutters” which are well known in the art can be combined with the urethane of coating 18, 118 to enhance certain of the above mentioned properties. Such “cutters” include, but are not limited to, Xylene, Xylol, mineral spirits, paraffin solvents, rubber solvents, toluene, acetone, n-butyl alcohol, n-butyl acetate, and others.

The “cutters” can be applied in any of a number of ratios of “cutter” to urethane as required to obtain the desired end characteristics/properties of coating 18, 118. For example, the coating 18, 118 can be applied in ratios of about 20% cutter and about 80% urethane, about 30% cutter and about 70% urethane, about 40% cutter and about 60% urethane, about 50% cutter and about 50% urethane, and others. In addition, those skilled in the art are well aware of suitable methods of applying coating 18, 118 to e.g. sheet 16, 16A, 16B (FIGS. 3, 6, 8, 11A, 11B), including brushing, rolling, electrostatic coating, spraying, wand spraying, curtain coating, and others.

Protective coating 18, like the remaining components of the display mat 10, is highly flexible, permitting mat 10 to be bent and rolled without cracking. Coating layers 18 may be applied in a number of ways such as through high volume, low pressure spraying, aerosol spraying, electrostatic coating, brush coating, curtain undercoating, rod coating, reciprocating coating, etc.

Grit layer 36 can be applied by broadcast spreading, drop spreading, sandblasting, etc. It can also be mixed in the coating material before application of the coating to sheet 16. The number of coating layers applied can vary from application to application as desired. Namely, a single coating layer can suffice in many instances, such as indoor applications, and other applications in which the coating lacks grit, or in applications in which the grit is mixed with the coating material prior to application of the coating.

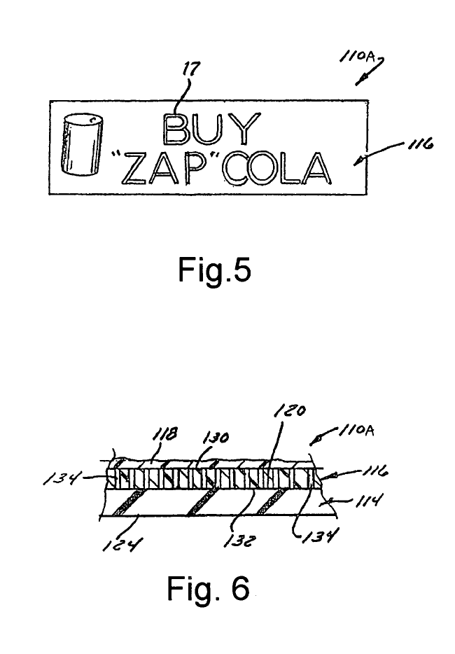

Referring now to FIGS. 5 and 6, a display mat 110A constructed in accordance with a second embodiment of the invention is illustrated. Mat 110A contains many of the same, and/or similar, components of mat 10 of the first embodiment, which are designated by the same reference numerals as the corresponding components of the first embodiment, incremented by 100. Display mat 110A therefore, includes a rubber substrate 114, a vinyl sheet 116, and a layer of protective urethane and/or coating material 118. As in the first embodiment, substrate 114 has upper and lower surfaces 120 and 124 and is fused to sheet 116 and is supported on a floor or other pedestrian surface, respectively. Sheet 116 has an upper surface 130 coated with a protective coating 118 and a lower surface 132 fused to upper surface 120 of substrate 114. Sheet 116 can also be perforated with holes 134 to prevent air from being trapped between sheet 116 and substrate 114 during the mat production process.

There are some differences between display mat 110A and display mat 10 of the first embodiment. For instance, sheet 116 and substrate 114 of this embodiment are of equal area so that sheet 116 completely overlies upper surface 120 of substrate 114. Rubber substrate 114 can be (i) absent or (ii) relatively thinner and can have a relatively smoother lower e.g. bottom surface 124 than the substrate of the first embodiment of mat 10. As discussed elsewhere herein, grit and/or a clear coating can be applied to bottom surface 124, if desired, to enhance the floor-gripping ability of substrate 114. Or, as desired, the grit can be absent from coating 118.

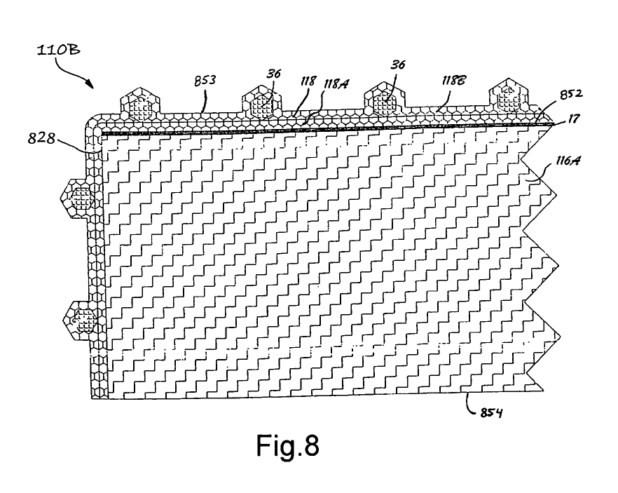

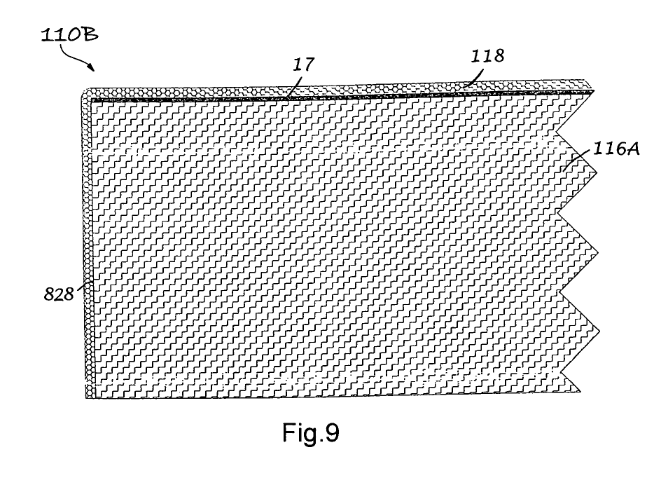

Referring now to FIGS. 8 and 9, mats 110B are exemplary of embodiments of the invention in which the mats do not utilize, or otherwise include, a substrate layer, e.g. FIGS. 8 and 9 depict mats of the invention which are adapted and configured to not require substrate 14, 114. Particularly, FIGS. 8 and 9 provide cross section views of alternative embodiments of display mat 110B.

Mat 110B includes a flexible polymeric sheet 116A having upper and lower surfaces, e.g. top and bottom surfaces 852, 854. Sheet 116A has a thickness of at least about, alternatively less than, 0.07 inch. A high-definition image 17 is printed onto top surface 852 using four-color process printing as is known for use on thin substrates such as paper. High-definition images are known in the art to be substantially similar to photographic images, especially when viewed from a distance. Four-color process printing and digital printing are typically acknowledged as the accepted methods of preparing such high-definition images on large areas such as posters. Lithography, screen printing, flat bed printing, and other suitable printing techniques can be used to print high definition images 17 onto sheet 116A.

A coating 118 overlies image 17 to offer protection and to optionally provide a durable non-slip outer surface 853. There is sufficient cohesion between sheet 116A, graphic image 17 and coating 118 to withstand repeated rolling and unrolling of mat 110B without separation of components thereof. Mat 110B also has sufficient stiffness and strength to lay flat on a carpet while supporting the weight of people standing thereon.

Sheet 116A is preferably a vinyl based, namely polyvinyl chloride (PVC), or other vinylidene chloride copolymer, product. In addition, sheet 16A includes sufficient diisononyl phthalate (DINP) plasticizer to make sheet 116A flexible enough to be rolled up, including without causing migration of e.g. ink or other colorant which is applied to top surface 852.

Sheet 116A, and thus mat 110B, can be stored in a rolled up position without damage. Sheet 116A is heat and light stabilized such that sheet 116A is not damaged by exposure to typical heat and light encountered in normal use over the expected use life of the mat. In addition, sheet 116A can be pigmented to provide a desired color upon which to print an image.

Those skilled in the art are well aware of other suitable additives, components of, and methods of fabricating, vinylidene chloride copolymer. Suitable additive packages can be used as desired, such as slip agents, anti-block agents, release agents, anti-oxidants, fillers, and plasticizers, to assist in controlling e.g. processing of the polymer material as well as to stabilize and/or otherwise control the properties of the finished processed product, also to control hardness, bending resistance, and the like of sheet 116A.

Bottom surface 854 can have a high enough coefficient of friction to prevent slippage between mat 110B and the underlying ground surface when in use. Bottom surface 854 is adapted for use with ground surfaces such as pavement, carpet, marble, tile, etc. and which surfaces may be, or may become, wet or soiled.

Graphics image 17 is comprised of inks printed onto top surface 852 via four-color process printing e.g. dot-matrix printing. Four-color process printing results in high-definition images which approach photographic quality imaging. The printing process optionally utilizes UV inks which are dried by UV light after printing. Solvent and water-based inks may also be used. Those skilled in the art are well aware of suitable UV inks, solvent-based inks, water-based-inks, and other inks, for printing graphics image 17.

Graphics image 17 preferably has a thickness of substantially less than 0.001 inch. Because graphics image 17 is directly printed onto sheet 116A and in light of the small thickness dimension of graphics image 17, strain between image 17 and sheet 116A is limited during the rolling up of the mat. This allows frequent or repeated rolling up of mat 110B without damage to graphics image 17, such damage as cracking or separation between components within mat 110B.

In FIG. 8 coating 118 includes a bottom coat 118A which is applied directly to graphics image 17. Grit 36 is positioned on bottom coat 118A before top coat 118B is applied over grit 36 and bottom coat 118A. Grit 36 provides increased traction between the mat and pedestrian traffic, especially when mat 110B is wet. Bottom coat 118A and top coat 118B can be, for example and without limitation, urethane-based coatings which are slip resistant and which provide sufficient durability that pedestrian traffic does not scuff, mar or otherwise unacceptably alter the appearance of graphics image 17 over the expected use life of the mat. FIG. 9 depicts the invention in which coating 118 is a single layer which is applied directly to image 17.

Coating 118 is flexible such that rolling and unrolling mat 110B does not cause the coating to break or separate from graphics image 17 or sheet 116A.

As shown in FIGS. 8 and 9, coating 118 covers graphics image 17 and may also cover edge 828 of mat 110B so as to prevent the outside environment from contacting image 17 through entry at edge 828. Coating 118 preferably has a thickness of about 0.002 inch or less.

As constructed, mat 110B provides a durable medium for high-definition graphics. Mat 110B is flexible enough to be rolled up without being damaged and performs well when being laid down, e.g. the mat conforms closely to the contours of the underlying surface quickly without having any edge or corner extending substantially upwardly from the underlying surface. In addition, mat 110B has sufficient strength to resist stretching and distortion such that graphics image 17 is not altered during rolling or unrolling, not when weight is applied to the surface of mat 110B (such as when a person walks or stands on mat 110B). When used on carpet, mat 110B has sufficient stiffness to support a person without sinking an unacceptable distance into the carpet, or separating from the carpet (bubbling) around the person's feet.

While providing flexibility, mat 110B also provides sufficient hardness or impact resistance to withstand the application of extreme pressures. For instance, a 100 pound woman wearing shoes with 0.06 square inch heel surfaces (0.25 inch by 0.25 inch) inflicts a pressure of at least 1,600 psi on the mat when her heel strikes. Accordingly, mat 110B is adapted and configured to resist e.g. long-term deformation when a pressure force of at least about 1,600 psi is applied to, for example, a 0.06 square inch area of mat 110B. The impact resistance of mat 110B is high enough such that mat 110B is not punctured or otherwise damaged during typical use which may include applications of forces as high as 4,000 psi.

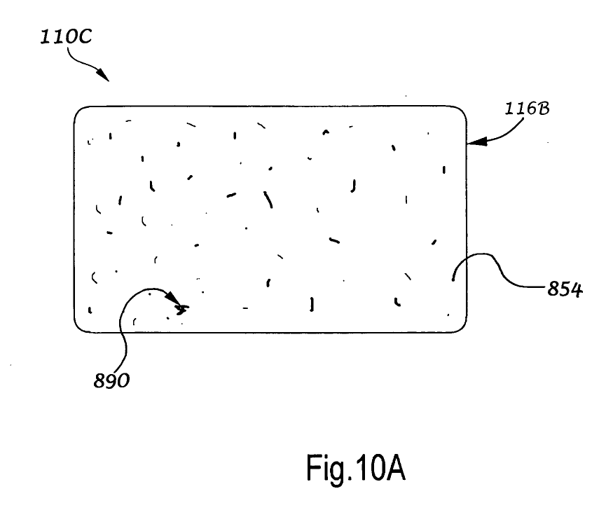

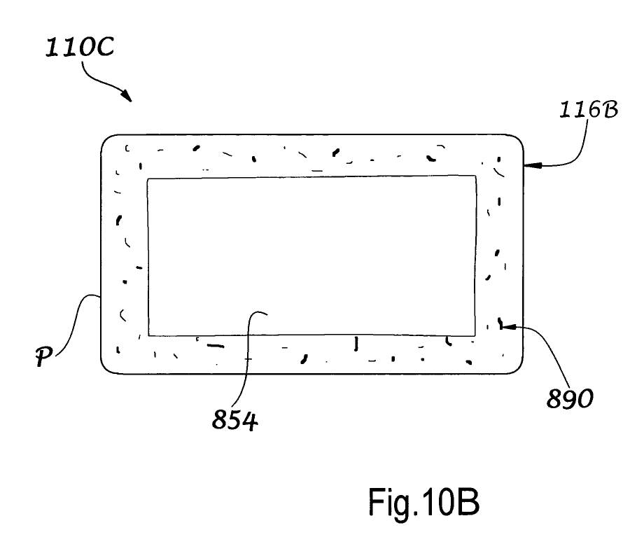

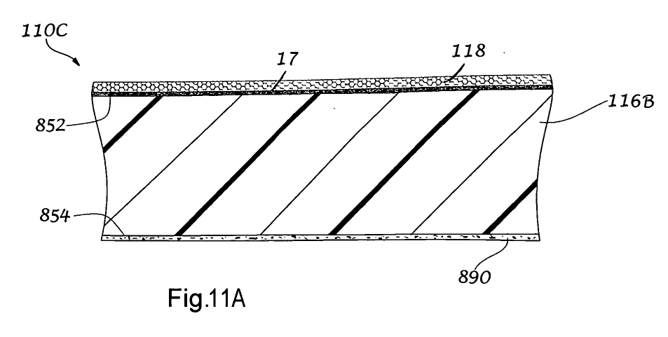

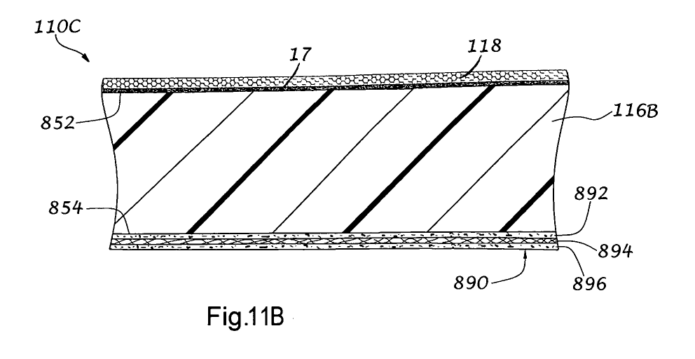

Referring now to FIGS. 10A, 10B, 11A, and 11B, in some embodiments, mat 110C defines an outer perimeter “P” and includes sheet 116B which is relatively thinner than, and/or otherwise differentiated from, sheet 116A. Also, mat 110C includes adhesive 890 which comprehends various attachment substances and/or attachment devices e.g., adhesives, adhesive strips, hook and loop fasteners, and/or other attachment devices. Adhesive 890 enables mat 11C to be attached to, and/or removably attached to, a desired surface such as a pedestrian traffic surface.

Sheet 116B has top and bottom surfaces 852, 854 which define a thickness dimension therebetween. Sheet 116B, illustrated in FIGS. 10A, 10B,11A, and 11B is relatively thinner than sheet 116A, illustrated in FIGS. 8 and 9. Namely, the thickness dimension of sheet 116B, between top and bottom surfaces 852, 854, is less than about 0.07 inch. For example, and without limitation, sheet 116B has a thickness dimension which is less than about 0.05 inch, optionally less than about 0.03 inch, optionally less than about 0.02 inch, and preferably less than about 0.01 inch, e.g. approximately 0.007 inch or less in thickness.

A high-definition graphics image 17 is printed onto top surface 852 using, for example and without limitation, four-color process printing as is known for use on thin substrates such as paper. High-definition images are known in the art to be substantially similar to photographic images, especially when viewed from a distance. Four-color process printing and digital printing are typically acknowledged as the accepted methods of preparing such high-definition images on large areas such as posters. Lithography, screen printing, flat bed printing, and other suitable printing techniques can be used to print high definition graphics images 17 onto sheet 116B. Image 17 can cover the entirety of top surface 852, or less than all of top surface, or spaced portions of top surface 852.

A coating 118 overlies image 17 and any portion of top surface 852 which is not covered by image 17. Coating 118 has abuse resistant properties thereby to protect the printed image 17 and the top surface 852 from the abuse of regular pedestrian use. Optionally, one or more layers of e.g. coating 118 can be utilized so as to provide a durable non-slip outer surface to mat 110C, such as the non-slip outer surface 853 as illustrated in FIG. 8 which can include grit 36.

There is sufficient cohesion between sheet 116B, graphics image 17 and coating 118 to withstand repeated rolling and unrolling of mat 110C without separation of components thereof. Mat 110C also has sufficient stiffness and strength to lay flat on a carpet while supporting the weight of people standing thereon.

Sheet 116B is an extruded, e.g. cast extruded, polymeric sheet material. Particularly, sheet 116B is an extruded polymer film of chlorinated hydrocarbons such as a vinyl based film. Preferably, sheet 116B is a polyvinyl chloride (PVC) based film which has an average molecular weight ranging from about 60,000 to about 150,000 and a specific gravity of between about 1.32 to about 1.45.

Sheet 116B includes conventional polyvinyl chloride (PVC) additive packs and/or other additives, including plasticizer in amounts sufficient to enable sheet 116B to bend, flex, and/or otherwise contort enough so that a user can “roll-up” mat 110C without causing migration of ink when applied to top surface 852 of sheet 116B. Accordingly, sheet 116B, and thus mat 110C, can be stored in a rolled up position without damage.

Exemplary plasticizers suitable for use with e.g. PVC in sheet 16 include, without limitation, epoxidized soy bean (ESO), diisononyl phthalate (DINP), and others.

In addition to utilizing plasticizer additives, the extrusion of sheet 116 can also include the use of other suitable additive package ingredients, such as slip agents, anti-block agents, release agents, anti-oxidants, fillers, and others, to assist in controlling e.g. processing of the polymer as well as to stabilize and/or otherwise control the properties of the finished processed product, also to control hardness, bending resistance, and the like of the film layer or layers which define sheet 116B.

Where sheet 116B is PVC, the percentage of PVC is preferably about 80 percent by weight to about 85 percent by weight PVC and about 15 percent to about 20 percent other additives and/or components, including plasticizer.

Also, the PVC, additives, and/or other components of sheet 116B are selected so as to enable mat 110C to be relatively ultra-violet (UV) resistant, and/or otherwise generally heat and light stabile such that sheet 116B is not damaged by exposure to typical heat, light, and/or other environmental stimulus encountered in normal use and over the expected use life of the mat. In addition, sheet 116B can be pigmented to provide a desired color upon which to print an image, alternatively transparent, semi-transparent, or translucent as desired when, for example, graphics image 17 is printed upon bottom surface 854 of sheet 116B and viewed generally through the sheet from top surface 852.

Graphics image 17 is comprised of ink printing onto top surface 852 of sheet 116B via preferably four-color process printing. As sheet 116B is made from a polymeric film which is relatively thinner than the polymeric material of which sheet 116A is made from, the printing onto sheet 116B can be relatively easier than printing on sheet 116B, especially when utilizing printing equipment which is particularly well suited to print upon relatively thin printing mediums such as e.g. paper. Four-color process printing results in high-definition images which approach photographic quality imaging. The printing process can utilize UV inks which are dried by UV light after printing. Certain solvent-based and water-based inks are also suitable for use. Those skilled in the art are well aware of suitable UV inks, solvent-based inks, water-based-inks, and other inks, for printing graphics image 17.

Graphics image 17 preferably has a thickness, e.g. an image thickness dimension, of substantially less than 0.001 inch. Because graphics image 17 is directly printed onto sheet 116B and in light of the thickness dimension of graphics image 17, there is reduced strain between graphics image 17 and sheet 116B when mat 110C is rolled up. This enables frequent and/or repeated rolling up of mat 110C without damage to graphics image 17 such as cracking or separation between components within, and/or layers of, mat 110C.

Coating 118 preferably has a thickness of about 0.002 inch or less and is preferably a urethane-derived coating, which can be “non-slip”, and which provides an acceptable level of durability. Namely, coating 118 is sufficiently durable so that pedestrian traffic does not scuff, mar or otherwise alter the view of graphic image 17 for the expected use life of the mat. Coating 118 is generally flexible whereby rolling and unrolling mat 110C does not cause the coating to break or separate from graphic image 17 or sheet 116B.

Coating 118 is applied directly upon/over, and communicates with, at least part of graphic image 17. When a printing technique and/or method is used which deposits e.g. small dots of ink in a dot-matrix pattern to create graphics image 17, a subsequently-applied coating 118 interfaces with, communicates with, and reacts with, the ink dots and correspondingly “blends” at least part of some of the ink dots with each other. Thus, the interaction between coating 118 and graphics image 17 is effective to blend at least parts of ones of the ink dots with at least parts of other ones of the ink dots. The result is a graphics image 17 whose appearance has been modified by the application of coating 118 whereby the image appears relatively less pixilated when viewed from a relatively close viewing distance or when the image is viewed under magnification, or is enlarged. Also, graphic image 17 appears relatively more realistic and/or to be of a relatively higher quality than a pure dot-matrix image which has not been so modified, when viewed from a relatively distant viewing distance.

The inventor contemplates that the liquid material applied as coating 118 at least partially mobilizes either or both of the printed material of image 17 of the top surface material of sheet 116B, whereby the circular dots of the dot matrix printing are distorted, moved and/or otherwise mobilized during the fusion of coating 118 into either or both of image 17 and sheet 116B.

In the assembled mat 110C, sheet 116B provides a durable medium for high-definition graphics. Sheet 116B enables mat 110C to be flexible enough to be rolled up without being damaged and also to perform well when laid down upon a pedestrian surface. In addition, sheet 116B has sufficient strength to resist stretching and distortion such that graphic image 17 is not altered during rolling or unrolling nor when weight is applied to the surface of mat 110C, such as when a person walks or stands on mat 110C.

When used on carpet, sheet 116B provides sufficient stiffness to support a person without sinking into the carpet or separating from the carpet (bubbling) around the person's feet. In addition, sheet 116B also provides sufficient hardness or impact resistance to withstand the application of certain extreme pressures. For instance, a 100 pound woman wearing shoes with 0.06 square inch heel surfaces (0.25 inch by 0.25 inch) inflicts a pressure of at least 1,600 psi on the mat when her heel strikes. Accordingly, mat 110C is adapted and configured to resist e.g. long-term deformation when a pressure force of at least about 1,600 psi is applied to, for example, a 0.06 square inch area of mat 110C. The impact resistance of mat 110C, provided at least in part by the impact resistance of sheet 116B, is high enough that mat 110C is not punctured or otherwise damaged during typical use which may include applications of forces as high as 4,000 psi.

Particularly, sheet 116B enables mat 110C to lie at least relatively closely to the contours of the underlying surface quickly without having any edge or corner extending substantially upwardly from the underlying surface. In preferred embodiments, when mat 110C spans across more than one type of pedestrian surface, sheet 16B enables mat 110C to lie closely to the contours of each of the more than one type of pedestrian surface.

As one example, sheet 116B is adapted and configured to generally maintain the integrity of its contour, profile, and/or other positional characteristics, as it spans across and/or between, for example, a relatively rigid pedestrian surface such as concrete wood, linoleum, tile, brick and others, and a relatively non-rigid pedestrian surface such as grass, sand, carpet and others. When a user/installer installs mat 110C upon and/or across multiple pedestrian surfaces, for example across e.g. a strip on concrete, a strip of grass, and a strip of carpet, mat 110C does not substantially buckle, crease, and/or otherwise deform, under the weight of a pedestrian walking upon mat 110C. Accordingly, mat 110C is adapted and configured to span across and/or between dissimilar pedestrian surfaces without posing a trip hazard by e.g. buckling, creasing, and/or otherwise deforming under the weight of pedestrians thereupon.

Referring now to FIGS. 10A and 10B, in preferred embodiments, mat 110C is attached to and/or removably attached to a pedestrian surface, such as surface 12 illustrated in FIG. 1. Mat 110C includes adhesive 890 which enables a user to attach and/or removably attach mat 110C to a pedestrian surface. Particularly, adhesive 890 is applied to and communicates with bottom surface 854 of sheet 116B.

In some embodiments, adhesive 890 covers and communicates with substantially the entirety of bottom surface 854. Namely, adhesive 890 defines a generally continuous adhesive layer which spans across generally the entire surface area, defined within perimeter “P”, of bottom surface 854.

In other embodiments, adhesive 890 covers and communicates with less than the entirety of bottom surface 854. Namely, adhesive 890 may cover only that portion of the bottom surface 854 which is adjacent perimeter “P.”

In addition, adhesive 890 can cover yet other portions of bottom surface 854 such as (i) generally medial portions within and generally between extremities of, perimeter “P”, (ii) one or more bands of adhesive which extend at least partially across surface 854, and (iii) other patterns, configurations, and/or orientations of adhesive 890 which cover less than the entirety of surface 854, as desired.

Adhesive 890 defines a thickness dimension of, for example, about 0.01 inch. However, actual thickness dimensions of adhesive 890 can vary, e.g. can be greater or less than 0.01 inch, as desired by the user and as dictated at least in part by the particular composition of adhesive 890, the particular composition of the sheet 16 upon which adhesive 890 is applied, and the particular composition of the pedestrian surface upon which the display mat is installed.

Referring now to FIG. 11A, adhesive 890 can be a singular, unitary layer. Accordingly, adhesive 890 can be applied to bottom surface 854 as, for example, a liquid, paste, or other medium depending on the exact adhesive 890 which is applied. In addition, adhesive 890 or the surface in which adhesive 890 is applied to e.g. mat 116B and/or surface 12 can further include, or have applied thereupon, certain other additives such as adhesive priming agents and others. In preferred embodiments, adhesive 890 is applied to bottom surface 854 at a location remote from the installation site of mat 110C and at a time prior to installation of mat 110C at such installation site.

Referring now to FIG. 11B, adhesive 890 can be a multiple layer structure, e.g. a two-sided adhesive tape. In some embodiments, adhesive 890 is an adhesive tape which has a length, a width, upper and lower adhesive layers 892, 896 which define an overall adhesive thickness dimension of about 0.01 inch therebetween. Adhesive 890 further includes a flexible substrate 894 which is disposed generally between the upper and lower adhesive layers 892, 896 and which realizes a tensile strength of at least about 0.5 kg/mm width, optionally about 0.6 kg/mm width.

An exemplary upper adhesive layer 892 can be a rubber based adhesive which includes a hydrocarbon tackifier. Such rubber based adhesive has an adhesive strength of approximately 50 g/mm, in terms of an adhesion to steel value. Upper adhesive layer 892 has an upper surface which communicates with and is adhesively attached to bottom surface 854 of sheet 116B. Upper adhesive layer 892 also has a lower surface which communicates with and is adhesively and/or otherwise attached to the flexible substrate 894.

Accordingly, adhesive 890 is attached to the remainder of mat 110C through the adhesive interfacing of upper adhesive layer 892 and sheet 116B. The adhesive of upper adhesive layer 892 can contain no solvents and can be a generally “non-residue” adhesive whereby upper adhesive layer 892 can be removed from the lower surface of sheet 116B, and leave generally no residue on sheet 116B.

Flexible substrate 894 extends generally along the entire length of, and across the entire width of, adhesive 890. Flexible substrate 894 can be cloth, e.g. a cloth substrate which generally provides separation between upper and lower adhesive layers 892, 896.

Lower adhesive layer 896 can be a rubber based adhesive which includes a hydrocarbon tackifier. Such rubber based adhesive has an adhesive strength of approximately 50 g/mm, in terms of an adhesion to steel value. Lower adhesive layer 896 has an upper most surface which communicates with and is adhesively and/or otherwise attached to the flexible substrate 894. Lower adhesive layer 896 also has a lower surface which communicates with and is adhesively attachable to the desired underlying pedestrian surface.

Accordingly, adhesive 890 is attached to the remainder of mat 110C through the adhesive interfacing of upper adhesive layer 892 and sheet 116B. Also, the adhesive 890 and thus mat 110C is attached to the pedestrian surface through the adhesive interfacing of lower adhesive layer 896 and the pedestrian surface. As with upper adhesive layer 892, the rubber based adhesive of lower adhesive layer 896 can contain no solvents and can be a generally “non-residue” adhesive whereby lower adhesive layer 896 can be removed from the underlying pedestrian surface to which it is adhered, and leave generally no residue upon the pedestrian surface.

When adhesive 890 is applied to bottom surface 854 of sheet 116B at a location remote from the installation site of mat 110C and/or at a time prior to installation of mat 110C, it can be desirable to include and/or otherwise provide a “backing material” (not illustrated) to communicate with adhesive 890 prior to the installation of mat 110C. Those skilled in the art are well aware of suitable “backing materials” such as polymeric based film release liners, polymeric coated paper release liners, and/or other “backing materials.”

The “backing material” (not illustrated) provides a physical barrier to adhesive 890 so as to prevent adhesive 890 from sticking, or otherwise becoming attached to, articles, surfaces, and/or other objects, which the user/installer does not desire the adhesive 890 to attach to. The “backing material” can be any size and configuration as desired by the user/installer. For example, in embodiments where adhesive 890 covers substantially all of bottom surface 854 (FIG. 10A), a single piece “backing material” can be used. A single piece backing material enables a user/installer to merely remove one piece of backing-material and to thereby expose substantially all of adhesive 890. However, as desired, the “backing material” can include a plurality of strips, sections, or other pieces of film which collectively conceal and/or protect adhesive 890.

Thus, the user/installer removes a plurality of pieces of “backing material” prior to completing the installation. Such plurality of pieces enables the user to first expose e.g. a small portion of adhesive 890, whereupon the positioning of the mat is readily accomplished without adhering the mat to the underlying surface. The exposed adhesive area is then lowered to the underlying surface, and lowered to the underlying surface, thereby fixing the mat in the desired location. With the mat so fixed in location, and part of the mat bonded to the underlying surface, the remaining backing strips are removed, and the remainder of the adhesive area is brought into contact with, and bonded to, the underlying surface.

Referring now to FIG. 10B, in embodiments in which adhesive 890 covers less than the entirety of bottom surface 854, a single piece “backing material” can be used, or a plurality of “backing material” pieces can be used. In embodiments where a single piece “backing material” is utilized, if desired, a user/installer can cut through the “backing material,” while taking care to not cut through sheet 116B, so as to convert a single piece “backing material” into a plurality of backing material pieces, for example, at the installation site.

To install mat 110C, the user/installer positions mat 110C at least generally near the proximity of installation. Then, the user/installer peals away the “backing material” from adhesive 890. Subsequently, the user/installer orients and/or otherwise positions mat 110C above and/or otherwise adjacent the pedestrian surface in which the mat will be installed upon and/or otherwise attached to. Finally, the user/installer presses against, steps downwardly upon, and/or otherwise applies a generally downwardly directed force against mat 110C and thereby attaches the mat to the desired pedestrian surface.

For installations in which the adhesive 890 is applied at the installation site, the above-mentioned steps are still generally followed. However, instead of peeling away the “backing material” to expose adhesive 890, the user/installer e.g. applies a liquid and/or other adhesive to mat 110C, to the pedestrian surface, or to both, prior to positioning the mat and applying the generally downwardly directed force against mat 110C.

Those skilled in the art will now see that certain modifications can be made to the apparatus and methods herein disclosed with respect to the illustrated embodiments, without departing from the spirit of the instant invention. And while the invention has been described above with respect to the illustrated embodiments, it will be understood that the invention is adapted to numerous rearrangements, modifications, and/or alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Similarly, while the disclosure hereof is detailed and exact to enable those skilled in the art to practice the invention, the invention is embodied in other structures in addition to the illustrated exemplary structures. The scope of the invention is defined in the claims appended hereto.

1. A display mat, comprising:
(a) a first layer comprising a generally planar polymeric sheet having an upper surface and a lower surface, and a thickness of no more than about 0.02 inch between the upper surface and the lower surface;
(b) a second layer of printing disposed on at least a portion of at least one of the upper and lower surfaces of said first layer; and
(c) a third generally transparent abuse resistant coating layer fused into, and comprising a unitary and inseparable body with, said second layer and said first layer.

2. A display mat as in claim 1 wherein said second layer is disposed on the upper surface of said first layer.

3. A display mat as in claim 1 wherein said second layer is disposed on the lower surface of said first layer.

4. A display mat as in claim 1 wherein said third layer comprises urethane.

5. A display mat as in claim 1 wherein said graphics and/or other indicia define an image having an image thickness dimension of no more than 0.001 inch.

6. A display mat as in claim 1 wherein said second layer comprises graphics and/or other indicia defined by a plurality dots of ink and/or other colorant whereby application of said generally transparent third coating layer causes blending of at least part of ones of the ink and/or other colorant dots with at least part of other ones of the ink and/or other colorant dots.

7. A display mat as in claim 1, further comprising a fourth layer of adhesive in adhering communication with the lower surface of said first layer, said fourth layer of adhesive having a top surface and a bottom surface, and an adhesive layer thickness between the top surface and the bottom surface, thickness of the fourth layer of adhesive being no more than about the thickness of the first layer.

8. A display mat, comprising:
(a) a first layer comprising a generally planar vinylidene chloride copolymer film having an upper surface and a lower surface[, and a thickness of no more than about 0.02 inch between the upper surface and the lower surface;
(b) a second layer of graphics and/or other indicia printed as generally circular dots in a dot matrix image on at least one of the upper and lower surfaces of said first layer; and
(c) a third generally transparent abuse resistant urethane-based coating layer fused into, and comprising a unitary and inseparable body with, said second layer and said first layer,
dots in the dot matrix image of said second layer being visually distorted, moved, or otherwise mobilized from circularity of such dots.

9. A display mat as in claim 8 wherein said first layer comprises a PVC polymer having an average molecular weight of about 60,000 to about 150,000.

10. A display mat as in claim 9 wherein said first layer has a specific gravity of about 1.32 to about 1.45.

11. A display mat as in claim 8 wherein said mat is adapted and configured to generally resist long-term deformation when a force of about 1,600 psi is applied to an area of about 0.06 square inch.

12. A display mat as in claim 8, further comprising a fourth adhesive layer having a top surface and a bottom surface, and a thickness between the top surface and the bottom surface, the thickness of the fourth adhesive layer being no more than the thickness of the first layer.

13. A display mat, comprising:
(a) a first layer comprising a generally planar polymeric sheet having an upper surface and a lower surface, and a thickness of no more than about 0.02 inch between the upper surface and the lower surface;
(b) a second layer of printing disposed on at least a portion of at least one of the upper and lower surfaces of said first layer; and
(c) a third layer of adhesive having a top surface and a bottom surface, and communicating with at least a portion of the lower surface of said first layer, a thickness of said third layer being defined between the top and bottom surfaces of said third layer.

14. A display mat as in claim 13 wherein the thickness of said third layer is less than the thickness of said first layer.

15. A display mat as in claim 13 wherein the thickness of said first layer is less than about 0.01 inch.

16. A display mat as in claim 13 wherein said second layer has an image thickness of less than 0.001 inch.

17. A display mat as in claim 13 wherein said first layer comprises an extruded vinylidene chloride copolymer film.

18. A display mat as in claim 17 wherein said first layer comprises no more than about 20 percent plasticizer.

19. A display mat as in claim 13, further comprising a fourth coating layer comprising generally transparent abuse resistant material fused into, and comprising a unitary and inseparable body with, said second layer and said first layer.

20. A display mat as in claim 13 wherein the third adhesive layer comprises a substrate having first and second opposing surfaces, the substrate being coated on the first surface with a first adhesive effective to bond the substrate to said first layer, and coated on the second surface with a second adhesive effective to releasably and bond the substrate to an underlying pedestrian surface such that the second adhesive releases cleanly from commonly-used manufactured pedestrian surfaces when said mat is pulled away from such pedestrian surfaces, while remaining bonded to said substrate.

21. A display mat as in claim 20 wherein the first adhesive is different from the second adhesive.
